(19) United States
(12) Patent Application Publication
(10) Pub. No.: US 2017/0111320 A1
(43) Pub. Date: Apr. 20, 2017

(54) METHOD OF PROCESSING A MESSAGE IN AN INTERCONNECTION DEVICE

(71) Applicant: BULL SAS, Les Clayes-Sous-Bois (FR)

(72) Inventors: Liana BOZGA, Meylan (FR); Louis DAVY, Poisat (FR); Jean-Olivier GERPHAGNON, Vif (FR)

(21) Appl. No.: 15/128,521

(22) PCT Filed: Mar. 12, 2015
(86) PCT No.: PCT/FR2015/050616

§ 371 Date: Sep. 23, 2016

(30) Foreign Application Priority Data
Mar. 26, 2014 (FR) 1452550

(51) Int. Cl. H04L 29/06

(52) U.S. Cl. CPC H04L 63/0263; H04L 63/0853; H04L 63/0218; H04L 43/106

(57) ABSTRACT

A method of processing a message by a first interconnection device, the method including: recording a first database of processing rules in the first interconnection device, recording an identifier of a second interconnection device in the first interconnection device, and processing a communication in accordance with local processing rules of the first local database of rules and with remote processing rules obtained from a second interconnection device which is identified by the identifier of the second interconnection device.

### TECHNICAL FIELD OF THE INVENTION

The invention relates to the interconnection device in the field of routing messages through a network. The invention also relates to the security of computer networks in which data packets, or messages, are routed.

Interconnection device means, in the framework of this application, any device that makes it possible to interconnect in an intelligent manner at least two data processing devices. This is referred to as interconnection device. This is in particular switches and routers.

### PRIOR ART

In a network environment, in order to manage security, it is essential to be able to define access rules to the equipment that is connected through it. In the current solution the network equipment makes it possible to define the access lists (ACL for Access Control List) containing rules to be applied on the data (messages or frames) circulating through said equipment. The application of said rules is done on each piece of equipment in an “autonomous” way and without global coherence on the scale of the network whether it is local or extended. This means that each piece of equipment has to define the rules and apply them at its own level and not in a homogeneous global way.

Because of this, if configurations are modified on a piece of equipment, that disagree with the global policy, whether voluntarily or involuntarily, the detection will be complex and a security breach potentially opened. However, this solution is the best if the security rules are different on each piece of equipment and without coherence. However this is rarely, if not ever, the case.

In practice the configurations are copied identically over all of the devices which is a source of errors, incoherencies and loss of performance. Indeed a device is congested with rules that correspond to packets that it will never receive. Yet the device tries to take these rules into account.

Note that in the existing solutions, in the framework of a “routed” network (i.e. a network wherein one or several pieces of equipments are in charge of defining the routes that the packets must take according to their origin and their destination) the management of the ACLs is often carried out on these pieces of equipment and the undefined rules on the terminal equipment.

In addition, if no ACL is defined on the switches that connect the terminal equipment (hosts) the access controls will be applied only in the case where the network frames are obliged to pass through the routing equipment. If the frames remain located at said switch the application of the rules will not be carried out.

### DISCLOSURE OF THE INVENTION

The invention aims to overcome all or a portion of the disadvantages identified hereinabove, and in particular to propose means for allowing interconnection devices to share a configuration, with this configuration being a set of processing rules.

In this design, an aspect of the invention relates to a method of processing a message by means of a first interconnection device characterised in that it comprises the following steps:
Recording, in the first interconnection device, of a first database of processing rules
Recording, in the first interconnection device, of an identifier of a second interconnection device,
Processing of a communication according to
   Local processing rules of the first local database of rules
   Remote processing rules obtained from a second interconnection device identified by an identifier of the second interconnection device.

In addition to the main characteristics which have just been mentioned in the preceding paragraph, the method/device according to the invention can have one or several additional characteristics among the following, considered individually or according to the technically permissible combinations:
the remote processing rules are obtained for each message processed.
the remote treatment rules are obtained at predetermined dates.
the remote rules, once obtained, are recorded locally in such a way as to be able to be reused.
that a remote processing rule is associated with an identifier of an interconnection device.
that a remote processing rule is associated with a time-date stamping.
the remote processing rules are erased according to at least their time-date stamping.
a rule comprising at least:
   A source address,
   A destination address,
   A processing instruction code from among at least:
      Block the message,
      Allow the message to pass
each processing rule is associated with a priority
it comprises a step of authentication of the first interconnection device by the second interconnection device

The invention also relates to a digital storage device comprising a file corresponding to instruction codes that implement the method according to one of the preceding claims.

The invention also relates to a device that implements the method according to one of the preceding claims.

### BRIEF DESCRIPTION OF THE FIGURES

Other characteristics and advantages of the invention shall appear when reading the following description, in reference to the annexed figures, which show:

FIG. 1, an illustration of the means making it possible to illustrate the implementation of the invention;

FIG. 2, an illustration of the steps of the method according to the invention.

[etc.]

For increased clarity, identical or similar elements are marked with identical reference signs on all of the figures.

The invention shall be better understood when reading the following description and when examining the figures that accompany it. The latter are presented for the purposes of information and in no way limit the invention.

### DETAILED DESCRIPTION OF AN EMBODIMENT

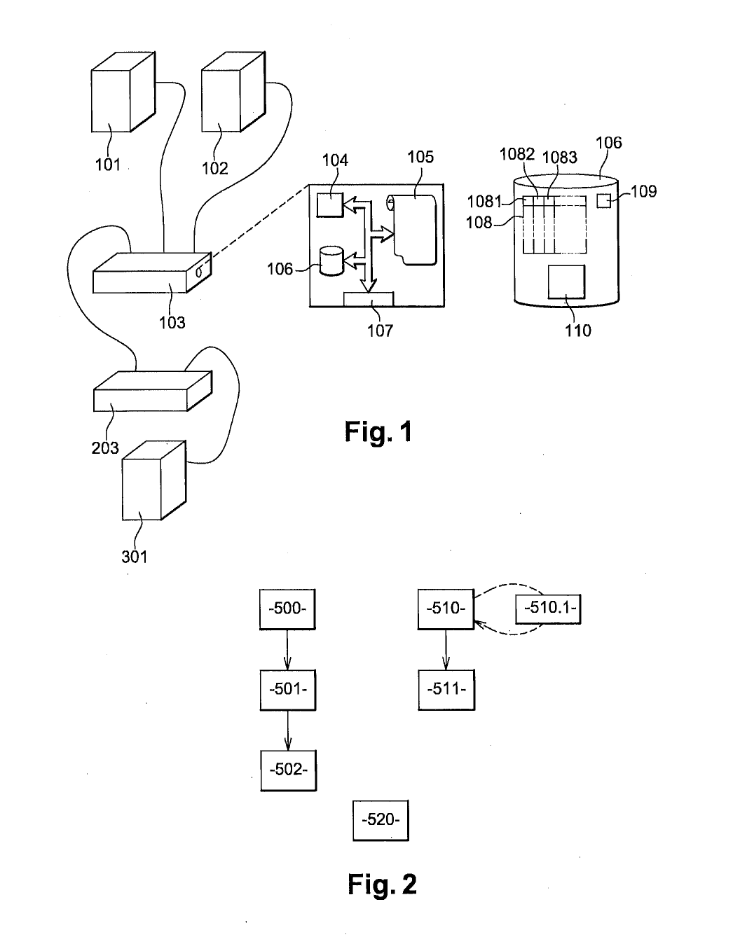

FIG. 1 shows a hardware architecture in which the invention can be implemented. FIG. 1 shows a first device 101 connected and a second device 102 connected by the intermediary of a first interconnection device 103.

An interconnection device is at least one device for processing messages emitted by the devices to which the interconnection device is connected. As a processing device the first interconnection device 103 comprises at least:
A microprocessor 104,
A programme memory 105 comprising at least instruction codes that correspond to all or a portion of the invention. For this description these instruction codes are at least those of a client portion of the invention
A storage memory 106,
A set 107 of connectors allowing for the connection of the interconnection device 103.

The elements described are those used for a clear description of the invention. The memories are elements, in the sense together of at least one electronic component, separated or are separate zones of the same element.

All or a portion of the invention is spoken of as the latter relates to a client-server application. There are therefore instruction codes that correspond to the client portion, and instruction codes that correspond to the server portion. In the implementations of the invention the client and server portions can be present on the same device.

In practice when an action is lent to the device the latter is carried out by a microprocessor of the device controlled by instruction codes recorded in a memory of the device.

FIG. 1 shows that the storage memory 106 of the first interconnection device 103 comprises a first database 108 of processing rules. In our example this database of processing rules is limited to a table, with each line of the table corresponding to a rule, with each rule having properties that correspond to columns of the table. A line is also called a record.

FIG. 1 shows that the storage memory 106 of the first interconnection device 103 comprises a zone 109 in order to record an address of a second interconnection device 203 connected to the first interconnection device 103. This zone is designated as an identification memory of the remote interconnection device. This is for example:
a dedicated configuration file,
a section of an existing configuration file,
a zone located at a predetermined address on the means for storage,
a line in a database
etc.

The second interconnection device 203 is also a processing device. It is similar to the first interconnection device 103. The second interconnection device 203 comprises a database of rules and of instruction codes corresponding to the invention. For this illustration these instruction codes correspond to a server portion of the invention.

An address is for example an address in the IPV4 format, i.e. an address according to the version 4 of the protocol IP. This could be an IPV6 address. This is only an example, in practice it is an identifier that can be routed over a network, whether it entails a an Ethernet, InfiniBand, ARIES, etc. network, the list is not complete. In this case the IP address is to be replaced with its equivalent: memory address, globally unique identifier (GUID) etc.

As such a rule comprises at least:
A property 1081 identifying source(s),
A property 1082 identifying destination(s),
A property 1083 action code.

For properties we speak of an identifier in order to designate:
An address, such as defined hereinabove, or
A network i.e. a set of addresses.

An action code is at least among:
Allow to pass, or
Block.

As such the processing of a message consists in determining which rules apply to it, and as such to apply to it the action that corresponds to the corresponding rule or rules. If several rules correspond with contradictory actions, a known conflict resolution mode is applied such as for example:
As each rule has an order number, i.e. ranking, it is the action of the first rule found which is applied, or
Blocking has priority, or
Each rules has a priority, it is the action that has the highest priority that is applied, or
. . . the list is not complete.

FIG. 1 shows a third connected device 301, connected to the second interconnection device 203.

FIG. 1 also shows that the storage memory 106 of the first interconnection device 103 comprises a second database 110 that has the same structure as the first database 108 of processing rules. This second database 110 is intended to record processing rules coming from other interconnection devices. We can then speak of a database 110 of remote processing rules.

In practice there can only be a single database with lines that have an additional property called “Origin” making it possible to record the origin of the rule according to whether it is:
Local: i.e. proper to the device comprising the database, or
Remote: i.e. coming from a device other than the one comprising the database. This Origin property can also record an interconnection device identifier which makes it possible to determine from which device it comes.

In general the following interconnection devices:
First interconnection device, and
Second interconnection device are together called a network. By extension it is considered that the devices connected to the those mentioned hereinabove are also part of the network which shall be designated in what follows as the first network.

FIG. 2 shows a step 500 of configuration of the first interconnection device 103. In this step a user, generally the administrator of the first network, updates the first base 108 of processing rules. Such an update requires a secure connection and is carried out conventionally:
Remotely
   Via a web interface (http), or a secure web interface (https), and an internet browser
   Via an ssh connection, i.e. in console mode,
   etc.
Locally
   By having a physical access to the device which makes it possible to connect to it via a cable connected to a dedicated connector, historically R8232, of the device: we are then in graphics mode or in console mode according to the device.

This here entails known modes for configuring an interconnection device.

In the invention we pass from the step 500 to a step 501 of recording an identifier of the second interconnection device 203 in the memory 109. This is carried out by adapting one of the configuration modes described hereinabove. In the case of a graphics configuration mode a key-entry zone is added that makes it possible to enter a value for the identifier of the second interconnection device. Validating this key-entry zone causes the updating of identification memory 109 of the remote interconnection device. In the case of a configuration mode via the command line, a new command is used, due to the invention, of which the execution causes the updating of the identification memory 109 of the remote interconnection device.

The memory 109 can contain:
An IPV4, IPV6 or other address.
A character string which can be resolved into an address by the intermediary of a DNS server or equivalent.

From the step 501 we pass to the step 502 of obtaining remote processing rules. In the step 502 the first interconnection device 103 produces a processing rules request message comprising at least:
A destination address, the identifier recorded in the identification memory 109 of the remote interconnection device,
A response address, that of the first interconnection device 103.
A predetermined instruction code: this instruction code is a rules request code.

Once the rules request message is produced, it is emitted by the first interconnection device 103.

In a step 510 of receiving a rules request message the second interconnection device 203 receives the processing rules request message emitted by the first interconnection device 103. This message is identified as a processing rules request message because:
It is intended for the second interconnection device, indeed the destination address is that of the second interconnection device;
It comprises an appropriate instruction code.

In this step the second device produces a processing rules transmission message comprising at least:
A destination address which is the value of the response address of the rules request message;
An issuing address that is the address of the device producing and emitting this message;
A predetermined instruction code: this instruction code is a code designating the message as a message for transmitting processing rules.
Zero or N message processing rules, with N greater than or equal to 1.

Once the rules transmission message is produced, it is emitted by the second interconnection device.

In a step 511, the first interconnection device 103 receives the processing rules transmission message. It retrieves therein the processing rules. It has as such obtained remote processing rules from a second interconnection device. This message is identified as a processing rules transmission message because:
It is intended for the first interconnection device, indeed the destination address is that of the first interconnection device;
It comprises an appropriate instruction code.

According to embodiments of the invention the remote processing rules are:
Maintained in a working memory, or
Recorded in a local database, for example the database 110 of remote processing rules.

The step 502 is implemented, for example, according to a predetermined interval. This predetermined interval makes it possible to determine dates on which the step 502 is implemented.

In a step 520 of message processing the first treatment device receives a message. This message is processed according to its characteristics in particular source and destination addresses. This processing is carried out according to the local processing rules and according to the remote processing rules. The processing of a communication message is here similar to a filtering.

In an alternative, which is not the most optimal, remote rules are requested at each processing of a communication message.

In a practical example, consider that:
The first device 101 connected to the address A1,
The second device 102 connected to the address A2,
The third device 301 connected to the address A3
The database 108 of local rules comprises the first following rules:
   Source=A1, Destination=A2, Action=Pass
A database of local rules of the second interconnection device comprises the following second rule:
   Source=*, Destination=A3, Action=Block
The first device receives the following communication message:
   Source=A1,
   Destination=A3,
   Message=Hello world!

Without the invention, the communication message would be blocked by the second interconnection device that it must pass through in order to reach the third connected device 301.

With the invention the first interconnection device has obtained the second rule. It therefore knows that the communication message must be blocked. This prevents it from having to transmit the communication message and as such makes it possible to save bandwidth.

Likewise, before the invention, in a network environment, for the management of security, the network equipment made it possible to define access lists (ACL for Access Control List) containing rules to be applied on the messages circulating through said equipment. The application of said rules is carried out on each piece of equipment in an “autonomous” manner and without global coherence on the scale of the network. This means that each piece of equipment must define the rules and apply them at its own level and not in a homogeneous global manner. This homogeneity must be maintained by hand. It is not rare, without the invention, to have certain pieces of equipment blocking messages while others allow them to pass. This can constitute security breaches.

With the invention it is possible to have a reference device that handles the configuration of a set of interconnection devices.

In an alternative of the invention the local processing rules and the remote processing rules are recorded in the same database which then comprises an additional column for recording the provenance of the rule, for example the address of its origin device, or simply a Boolean marker indicating whether or not it is a local rule.

In another alternative of the invention an interconnection device obtains processing rules from several remote devices. Note here that a remote device is not necessarily an interconnection device. It is at least one processing device that implements the server portion of the invention. The server portion of the invention is the ability to respond to rule request messages. The client portion of the invention is the ability to emit rule request messages and to process the responses to these messages.

In an alternative of the invention a remote rule is associated with a time-date stamping. This makes it possible to define a default lifespan for the rule, and/or a duration after which the remote device must be asked where the rule comes from if the latter is still valid. Such a time-date stamping also makes it possible to calculate an age for the rule. An age is the time calculated between the current date and the time-date stamping. In an alternative the rules for which the age exceeds a predetermined value are ignored.

In an alternative of the invention a remote rule is associated with a version identifier which makes it possible to not re-emit remote rules of which the version has not changed on the reference device.

In an alternative of the invention, as each rule is associated with a unique rule identifier, the remote rules are deleted if they are not received in the response to a rules emission request message. This absence means that the rules in question have been deleted on the source device of the rules and that this deletion is passed on in cascade on the devices that are synchronised on the source device.

In an alternative of the invention each rule is associated with a priority, with the rule that has the highest priority being applied with priority over the others.

A method of implementation has just been described wherein the client, i.e. the first interconnection device, requests processing rules. This is referred to as the “pull” mode.

The invention remains valid with an implementation mode wherein the second interconnection device, or a remote device, pushes the rules to the first interconnection device. In this case, by symmetry, the equivalent of the memory 109 in order to record an address of a second interconnection device on the second device becomes a zone for recording at least one address of a device to which the processing rules have to be pushed. The rule transmission message is in this case produced without a request having been received. This is then referred to as “push” mode or subscriber mode: a client device subscribes to a server device.

In an alternative of the invention on the server device the rules to be transmitted are marked as such. This marking is, for example, carried out via an additional column in a table of rules. This can also be a file comprising rules to be emitted. Being in this file is then a marking.

The steps of the invention are distributed over time. In practice the database of processing rules are up to date at the time a message is processed.

A time-date stamping is:
a date,
a timestamp, or
a version number. In the case of a version number, an operation can be used of the type of that used for the management of serial numbers of SOA records for DNS. In this latter case files of rules can be considered manages as zone files of a DNS server.
The list is not complete.

The invention has been described with simple processing rules, based on source and destination addresses. In practice the invention remains valid with more complex rules that use, for example, the notions of protocols (tep, udp, ftp, http) or packet inspection.

The description comprises implicitly the notion of recursion. That is to say that a first interconnection device, when it retrieves the rules of a second interconnection device, can obtain rules that the second device has itself obtained from a third interconnection device.

In an alternative of the invention the zone 109 in order to record an address of a second device makes it possible to record several addresses, with each one of these addresses corresponding to an interconnection device. In this case the first interconnection device obtains processing rules from several second interconnection devices. In this case also, where applicable, a conflict resolution mode is used.

In an alternative of the invention, the step 510 of receiving a rules request method comprises a preliminary step 510.1 of authenticating the issuer of the rules request message. A simple version is the test of the existence of the response address of the message in the list of authorised requestors. If the response address exists, then the rules are emitted. If the address does not exist, then no response is provided to the rules request message.

In a more elaborate alternative, the authentication is based on the set up of a challenge, for example based on certificates with each device having its own, between the device emitting the message and the device to which the message is addressed.

In an alternative of the invention, an attempt to obtain the processing rules is triggered by the receiving of a specific message. Such a message is, for example, emitted in distribution mode by an interconnection device of which at least one processing rule has just been modified.

1. A method for processing a message by a first interconnection device, the method comprising:
recording, in the first interconnection device, a first database of processing rules;
recording, in the first interconnection device, an identifier of a second interconnection device,
processing a communication according to
local processing rules of the first local database of rules, and
remote processing rules obtained from a second interconnection device identified by the identifier of the second interconnection device.

2. The method according to claim 1, wherein the remote processing rules are obtained for each message processed.

3. The method according to claim 1, wherein the remote treatment rules are obtained at predetermined dates.

4. The method according to claim 1, wherein the remote rules, once obtained, are recorded locally in such a way as to be able to be reused.

5. The method according to claim 4, wherein a remote processing rule is associated with an identifier of an interconnection device.

6. The method according to claim 1, wherein a remote processing rule is associated with a time-date stamping.

7. The method according to claim 6, wherein the remote processing rules are erased according to at least their time-date stamping.

8. The method according to claim 1, wherein a rule comprises:
a source address,
a destination address,
a processing instruction code from among at least:
block the message,
allow the message to pass.

9. The method according to claim 1, wherein each processing rule is associated with a priority.

10. The method according to claim 1, further comprising authenticating the first interconnection device by the second interconnection device.

11. A digital storage device comprising a file corresponding to instruction codes that implement the method according to claim 1.

12. A device implementing the method according to claim 1.
